(19) United States
(12) Patent Application Publication
(10) Pub. No.: US 2011/0249563 A1
(43) Pub. Date: Oct. 13, 2011

(54) Dynamic Adaptation of Downlink RLC PDU Size

(76) Inventors: Simone Provvedi, Twickenham (GB); Anders Jonsson, Taby (SE)

(21) Appl. No.: 13/075,254

(22) Filed: Mar. 30, 2011

Related U.S. Application Data
(60) Provisional application No. 61/322,411, filed on Apr. 9, 2010.

(51) Int. Cl. H04W 24/00

(52) U.S. Cl. 370/241

(57) ABSTRACT

Embodiments herein dynamically adapt the size of downlink Radio Link Control (RLC) protocol data units (PDUs) sent by a radio network controller (RNC) to a user equipment (UE) via a base station. Notably, the RNC effectively matches downlink RLC PDU size to the radio conditions at the UE using one or more indirect indicators of those radio conditions. Example indirect indicators include active set size, common pilot channel power, and the number of positive RLC PDU acknowledgments received, to name a few. The embodiments therefore prove particularly advantageous to wireless communication systems based on existing standards that already provide the RNC with such indirect indicators, since no new or additional control signaling need be introduced. Method embodiments herein thus include determining one or more indirect indicators of radio conditions at the UE, and dynamically adapting the size of downlink RLC PDUs in dependence on those one or more indirect indicators.

### RELATED APPLICATIONS

This application claims priority to U.S. Provisional Patent Application Ser. No. 61/322,411, titled “Downlink RLC PDU Size Adaptation,” filed 9 Apr. 2010, and incorporated herein by reference in its entirety.

### TECHNICAL FIELD

The present invention generally relates to radio link control (RLC) in wireless communication systems, and particularly relates to adapting RLC protocol data unit (PDU) size.

### BACKGROUND

Many wireless communication systems, including those based on High-Speed Packet Access (HSPA) standards, functionally split radio access processing between geographically separated nodes: a radio network controller (RNC) and a base station (or NodeB). A base station contains the actual radio equipment for communicating with one or more user equipment (UE) over radio resources. An RNC manages those radio resources.

Responsible for different parts of radio access functionality, an RNC and a base station terminate different protocol layers. A base station terminates relatively lower layers including a Medium Access Control (MAC) layer (or at least a sub-layer thereof), while an RNC terminates relatively higher layers including a Radio Link Control (RLC) layer.

The RLC layer, in particular, receives data packets at the RNC (known as RLC Service Data Units, SDUs) that are to be sent to a particular UE in the downlink. The RLC layer segments these RLC SDUs into smaller units known as RLC Protocol Data Units (PDUs). The RLC layer then sends those downlink RLC PDUs to the UE, via the base station, over an RLC link. To provide error-free delivery, the RLC layer retransmits any downlink RLC PDUs that were not successfully received by the UE.

If downlink RLC PDUs are too large to send to the UE over the radio resources, the base station relays them to the UE in segments. Specifically, the MAC layer at the base station segments the RLC PDUs into smaller MAC PDUs. Because the base station has knowledge of the radio conditions at the UE, the MAC layer sizes the MAC PDUs to match those radio conditions. Once the UE successfully receives all of the MAC PDUs associated with a particular RLC PDU, the UE can reconstruct that RLC PDU.

Known implementations of the RLC layer in such systems statically fix the size of downlink RLC PDUs. That is, the downlink RLC PDU size is pre-configured at system setup to be a particular size and remains at that size irrespective of live system operations. In order to sustain high data rates, the downlink RLC PDU size must be statically fixed to a large size.

Problematically, however, a large downlink RLC PDU size causes a number of complications and inefficiencies in the system. Radio condition deterioration at the UE, for example, leads to excessive segmentation of large RLC PDUs (into MAC PDUs) at the base station. This excessive segmentation causes substantial overhead in the transmission of RLC PDUs to the UE, both in terms of actual data that must be sent and in terms of the considerable processing required at the base station and UE. More critically, excessive segmentation substantially lowers the probability that the UE will correctly receive all MAC PDU segments that form any given RLC PDU, meaning that a greater number of RLC PDU retransmissions will be required. A statically configured large RLC PDU size also means that RLC timer settings needs to be set conservatively in order to avoid unnecessary RLC retransmissions in poor radio conditions. This inevitably degrades system performance.

### SUMMARY

Embodiments herein dynamically adapt the size of downlink RLC PDUs sent by an RNC to a UE via a base station. Notably, the embodiments effectively match downlink RLC PDU size to the radio conditions at the UE using one or more indirect indicators of those radio conditions. The embodiments therefore prove particularly advantageous to wireless communication systems based on existing standards that already provide the RNC with these indirect indicators, since no new or additional control signaling is needed.

More particularly, an RNC according to one or more embodiments includes a communication interface and one or more processing circuits, including a determination circuit and an RLC controller. The communication interface is configured to communicate with a UE over an RLC link via a base station. The determination circuit is configured to determine one or more indirect indicators of radio conditions at the UE. Contrasted with direct indicators such as channel quality indicators (CQIs) that directly measure radio conditions at the UE, indirect indicators as used herein relate to the UE's location, data rate, or the like and reflect radio conditions at the UE only indirectly. The RLC controller is configured to dynamically adapt the size of downlink RLC PDUs transmitted over the RLC link, in dependence on these one or more indirect indicators.

In general, the RLC controller decreases the RLC PDU size if radio conditions at the UE have worsened, as indicated by the one or more indirect indicators, and increases the RLC PDU size if radio conditions at the UE have improved. Note that, in some embodiments, the RLC controller adapts RLC PDU size in this way by evaluating the one or more indirect indicators to derive a quantitative or qualitative value (or range of values) that directly describes radio conditions at the UE, and then actually adjusting RLC PDU size as a function of that value (or range of values). In other embodiments, though, the RLC controller adapts RLC PDU size as a function of actual values (or ranges of values) for the one or more indirect indicators themselves (i.e., without deriving a direct description of the radio conditions at the UE). For example, the RLC controller may determine RLC PDU size based on a defined mapping between different RLC PDU sizes and values (or ranges of values) for the one or more indirect indicators. Thus the RLC controller in a sense embodies an implicit understanding of how the one or more indirect indicators relate to radio conditions at the UE.

In some embodiments, at least one indirect indicator relates to at least a relative geographic location of the UE. Such an indirect indicator may comprise, for instance, the number of cells included in an active set of the UE, the power with which the UE has received a common pilot channel transmitted from a neighboring cell, and/or actual geographical location information as generated by location services. Regardless, provided with such an indirect indicator, the RLC controller may effectively utilize different RLC PDU sizes for different UE locations, based on an understanding that the UE experiences different radio conditions at those different locations.

Alternatively or additionally, at least one indirect indicator relates to the rate at which downlink RLC PDUs are sent or received over the RLC link (i.e., the RLC data rate from the perspective of the RNC or the UE). The indirect indicator may comprise, for example, the number of positive RLC PDU acknowledgments received from the UE over a period of time, or the rate at which downlink RLC PDU sequence numbers are consumed at the RNC. In any event, provided with such an indirect indicator, the RLC controller may effectively utilize different RLC PDU sizes for different RLC data rates, based on an understanding that those different rates reflect different radio conditions at the UE.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication system that includes a radio network controller (RNC) geographically separated from a base station according to one or more embodiments herein.

FIG. 2 is a block diagram illustrating details of the RNC in FIG. 1, according to at least one embodiment.

FIG. 3 is a logic flow diagram illustrating downlink RLC PDU adaptation according to one or more embodiments.

FIG. 4 is a logic flow diagram illustrating a method implemented by the RNC in FIG. 1, according to at least one embodiment.

### DETAILED DESCRIPTION

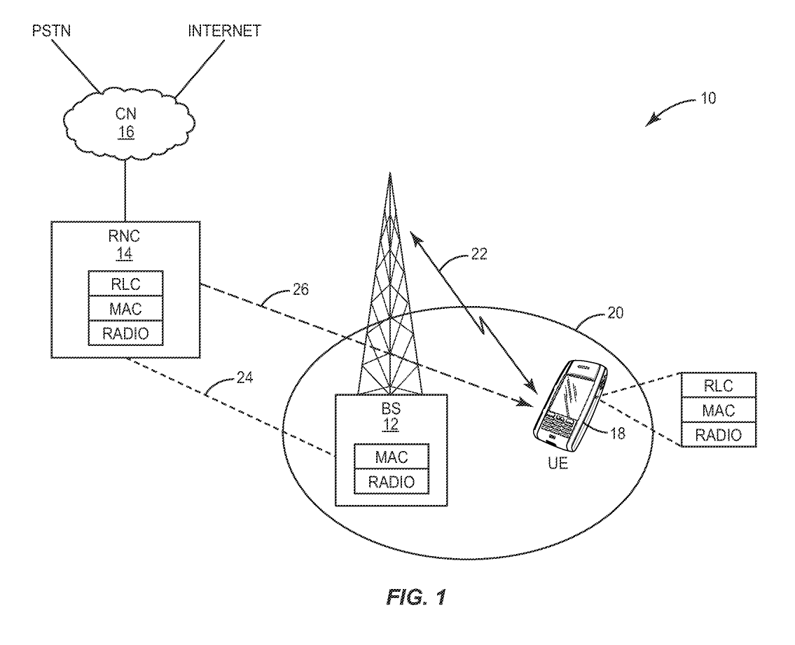

FIG. 1 depicts a simplified example of a wireless communication system 10 according to one or more embodiments. As shown, the system 10 includes a base station 12, a radio network controller (RNC) 14, and a core network (CN) 16.

The base station 12 contains radio equipment for communicating with one or more user equipment (UE) 18 in a serving cell 20, over radio resources 22. The RNC 14 is geographically separated from the base station 12 and communicates with the base station 12 over a backhaul link 24. Though separated from the base station 12, the RNC 14 actually manages the base station's radio resources 22. The CN 16 communicatively couples the RNC 14 to other systems, such as the as the Public Switched Telephone Network (PSTN), the Internet, and the like.

Responsible for different parts of radio access functionality, the base station 12 and RNC 14 terminate different protocol layers. The base station 12 terminates relatively lower layers including the Medium Access Control (MAC) layer (or at least a sub-layer thereof), while the RNC 14 terminates relatively higher layers including the Radio Link Control (RLC) layer.

In this regard, the RNC 14 receives data packets (known as RLC Service Data Units, SDUs) from the CN 16 that are to be sent to the UE 18 in the downlink. The RNC 14 segments these RLC SDUs into RLC Protocol Data Units (PDUs) of equal size. As explained more fully below, the particular size of the RLC PDUs may be dynamically adapted by the RNC 14, e.g., from one RLC SDU to another. Regardless, the RNC 14 sends the resulting RLC PDUs to the UE 18, via the base station 12, over an RLC link 26 (a link between the RNC 14 and the UE 18 at the RLC layer).

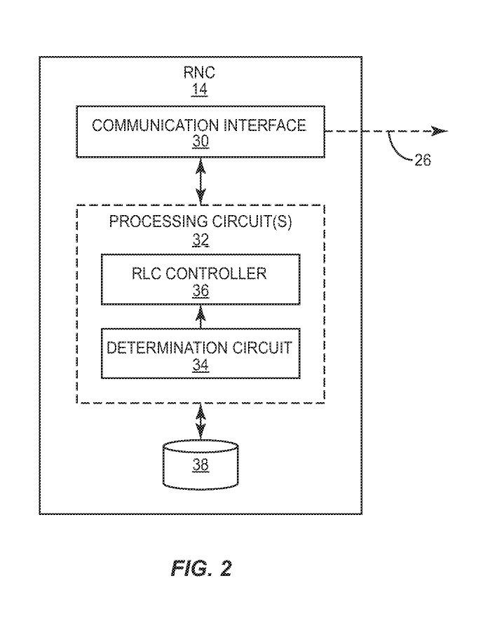

FIG. 2 illustrates the RNC 14 in greater detail, for elaborating on precisely how the RNC 14 dynamically adapts downlink RLC PDU size according to one or more embodiments. As shown, the RNC 14 includes a communication interface 30 and one or more processing circuits 32, including a determination circuit 34 and an RLC controller 36. The communication interface 30 is configured to communicate with the UE 18 over the RLC link 26 via the base station 12. The determination circuit 34 is configured to determine one or more indirect indicators of radio conditions at the UE 18. And, finally, the RLC controller 36 is configured to dynamically adapt the size of downlink RLC PDUs transmitted over the RLC link 26, in dependence on those one or more indirect indicators.

Contrasted with direct indicators such as channel quality indicators (CQIs) that directly measure radio conditions at the UE, indirect indicators as used herein relates to the UE's location, data rate, or the like and reflect radio conditions at the UE only indirectly. Adapting RLC PDU size based on such indirect indicators of radio conditions, rather than direct indicators, proves particularly advantageous. Indeed, existing standards for many wireless communication systems, such as those based on HSPA, already provide an RNC with one or more of the indirect indicators herein. With respect to these existing standards, therefore, present embodiments do not introduce new or additional control signaling, and do not require modification to system nodes other than the RNC.

Turning back to details of the example RNC 14, the determination circuit 34 in some embodiments “determines” one or more of the indirect indicators by receiving those indicators from another entity, e.g., in a report or other message incoming to the RNC 14. In the same or other embodiments, the determination circuit 34 “determines” one or more of the indirect indicators by performing calculations or other analyses to derive the indicators according to its own processing.

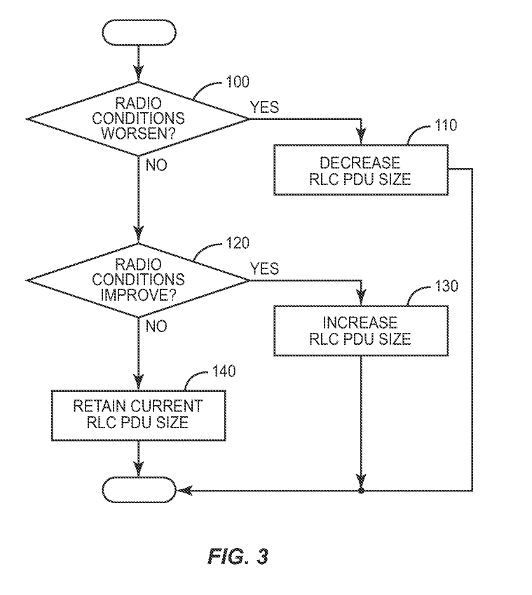

Irrespective of precisely how the determination circuit 34 determines the one or more indirect indicators, the RLC controller 36 dynamically adapts the downlink RLC PDU size based on those indicators. In general, and as shown in FIG. 3, the RLC controller 36 decreases the RLC PDU size (Block 110) if radio conditions at the UE 18 have worsened (Block 100), as indicated by the one or more indirect indicators. Conversely, the RLC controller 36 increases the RLC PDU size (Block 130) if radio conditions at the UE 18 have improved (Block 120), as indicated by the one or more indirect indicators. Of course, if the indicated radio conditions have remained the same, the RLC controller 36 may retain the current RLC PDU size (Block 140).

Note that, in some embodiments, the RLC controller 36 adapts RLC PDU size in this way by evaluating the one or more indirect indicators to derive a quantitative or qualitative value (or range of values) that directly describes radio conditions at the UE 18, and then actually adjusting RLC PDU size as a function of that value (or range of values). For example, in at least one embodiment the RLC controller 36 evaluates the one or more indirect indicators to determine in which of a plurality of predefined qualitative ranges the radio conditions at the UE 18 fall. These predefined qualitative ranges may include, for instance, “good,” “fair,” and “poor” radio condition ranges, as defined by predefined values or ranges of values for the one or more indirect indicators. Regardless, the RLC controller 36 then adapts the RLC PDU size responsive to changes in the qualitative range in which the radio conditions at the UE 18 fall.

As a specific example, the RLC controller 36 may be configured to apply different RLC PDU sizes when the radio conditions fall within different qualitative ranges (e.g., a large size for the “good” range, a medium size for the “fair” range, and a small size for the “poor” range). These different sizes may be predefined within a look-up table or other data structure that is stored in memory 38 at the RNC 14 and that maps the different qualitative ranges to respective RLC PDU sizes. Or, the sizes may be dynamically calculated. Of course, one or more embodiments use potentially much finer granularity for the qualitative ranges (i.e., more than just three ranges), and correspondingly use much finer granularity for adjusting the RLC PDU size.

In other embodiments, though, the RLC controller 36 adapts RLC PDU size as a function of actual values (or ranges of values) for the one or more indirect indicators (i.e., without deriving a direct description of the radio conditions at the UE 18). For example, the RLC controller 36 may determine the RLC PDU size based on a defined mapping between different RLC PDU sizes and values (or ranges of values) for the one or more indirect indicators. Thus the RLC controller 36 in a sense embodies an implicit understanding of how the one or more indirect indicators relate to radio conditions at the UE 18.

With the above description of the RNC 14 in mind, various embodiments will now be described in the context of specific indirect indicators. In some embodiments, at least one indirect indicator relates to at least a relative geographic location of the UE 18. That is, the indirect indicator may relate to the UE's location in relative terms (which describe the UE's location relative to another location, e.g., the center of the cell 20) or in absolute terms (which describe the UE's location in a coordinate system). Provided with such an indirect indicator, the RLC controller 36 may effectively utilize different RLC PDU sizes for different UE locations, based on an understanding that the UE 18 experiences different radio conditions at those different locations.

In at least one embodiment, for instance, the indirect indicator comprises the number of cells included in an active set of the UE 18 (also referred to as the active set size). The active set of the UE 18 includes those cells 20 to which the UE is connected. Generally, the active set includes more cells 20 the farther the UE is from the center of the cell 20 (which coincides with poorer radio conditions), and includes fewer cells 20 the closer the UE is to the center of the cell 20 (which coincides with better radio conditions). The number of cells included in the UE's active set, therefore, relates to the UE's location relative to the cell center and indirectly indicates the radio conditions at the UE 18.

Provided with such an indirect indicator, the RLC controller 36 dynamically adapts the size of downlink RLC PDUs as a function of the active set size. In some embodiments, for instance, the RLC controller 36 determines the RLC PDU size from a look-up table or other data structure in memory 38 that embodies a defined mapping between different RLC PDU sizes and different active set sizes. This mapping generally applies a larger RLC PDU size the smaller the active set size, and a smaller RLC PDU size the larger the active set size.

In the same or other embodiments, an indirect indicator may also comprise which particular cells are included in the UE's active set rather than simply the number of cells. The RLC controller 36 in these embodiments may map different RLC PDU sizes to different active set instances, where different instances include different cells in the active set.

In yet other embodiments, the indirect indicator comprises the power with which the UE 18 has received a common pilot channel (CPICH) transmitted from a neighboring cell (also referred to as a neighboring CPICH power). Generally, the greater such power, the farther the UE 18 is from the center of its serving cell 20 (which coincide with poorer radio conditions), and the smaller such power, the closer the UE 18 is to the center of its serving cell 20 (which coincides with better radio conditions). This power therefore relates to the UE's location relative to the cell center and indirectly indicates the radio conditions at the UE 18.

Provided with such an indirect indicator, the RLC controller 36 dynamically adapts the size of downlink RLC PDUs as a function of the neighboring CPICH power. In some embodiments, adaptation is performed as a function of actual values for this power. In other embodiments, though, adaptation is performed based on the reception of reports that notify the RNC 14 when the neighboring CPICH power has risen above or fallen below a power threshold. In HSPA standards, such reports are referred to as events 1E and 1F. If a report indicates the neighboring CPICH power has risen above the threshold, the RLC controller 36 decreases RLC PDU size, e.g., to a predefined small size. Or, if a report indicates the neighboring CPICH power has fallen below the threshold, the RLC controller 36 increases RLC PDU size, e.g., to a predefined large size.

In still other embodiments, the indirect indicator comprises actual geographic location information for the UE 18, such as that provided by location services (e.g., GPS coordinates or direction and rate of UE travel). In this case, the RNC 14 in some embodiments stores area-specific radio condition characteristics in memory 38 (or retrieves those characteristics from another node). Such characteristics describe radio conditions in different geographic areas of the system 10, and may be dynamically updated from time to time. A particular area may be described quantitatively or qualitatively as an area of characteristically poor radio conditions, for example, based on that area historically having a high incidence of dropped calls, low data rate service, excessive retransmissions, etc. The RLC controller 36 determines the geographic location of the UE 18 from the actual geographic location information, determines the radio conditions at the UE 18 with reference to the stored area-specific radio condition characteristics, and dynamically adapts RLC PDU size as appropriate.

In other embodiments, though, the RLC controller 36 is simply configured to use certain RLC PDU sizes for certain UE locations. That is, the controller 36 merely maps different RLC PDU sizes to different UE locations, without actually evaluating area-specific radio condition characteristics as discussed above. In this case, the mapping actually embodies an implicit understanding of how the UE's location relates to radio conditions at the UE 18.

Alternatively or additionally, at least one indirect indicator relates to the rate at which downlink RLC PDUs are sent or received over the RLC link 26 (i.e., the RLC data rate from the perspective of the RNC 14 or the UE 18). Provided with such an indirect indicator, the RLC controller 36 may effectively utilize different RLC PDU sizes for different RLC data rates, based on an understanding that those different rates reflect different radio conditions at the UE 18.

In at least one embodiment, for instance, the indirect indicator comprises the number of positive RLC PDU acknowledgments received from the UE 18 over a period of time. Such acknowledgements may be received in RLC status reports periodically sent by the UE 18 to the RNC 14. In general, the more positive acknowledgements received at the RNC 14, the higher the RLC data rate and the better the radio conditions at the UE 18. Conversely, the fewer positive acknowledgements received at the RNC 14, the lower the RLC data rate and the worse the radio conditions at the UE 18. Positive RLC PDU acknowledgements therefore relate to the RLC data rate from the perspective of the UE 18 and indirectly indicate the radio conditions at the UE 18.

Provided with such an indirect indicator, the RLC controller 36 in some embodiments dynamically adapts the size of downlink RLC PDUs as a function of the number of positive RLC PDU acknowledgements received. In this case the RLC controller 36 may determine the RLC PDU size from a look-up table or other data structure in memory 38 that embodies a defined mapping between different RLC PDU sizes and different numbers of positive RLC PDU acknowledgements. This mapping generally applies a larger RLC PDU size the more positive RLC PDU acknowledgement received, and a smaller RLC PDU size the fewer positive RLC acknowledgements received.

The RLC controller 36 in other embodiments first calculates or derives the RLC data rate from the number of positive RLC PDU acknowledgements received. The RLC controller 36 makes this calculation, for instance, based on knowledge of the RLC PDU sizes used for the positively acknowledged RLC PDUs. The RLC controller 36 may then actually adapt RLC PDU size as a function of the RLC data rate.

Such adaptation may be based on a closed or semi-closed decision loop at the RNC 14, whereby the RLC controller 36 increases or decreases the RLC PDU size in predefined increments. In this way, the RLC controller 36 makes stepwise up or down changes in RLC PDU size, such that the size adjustments trend toward an RLC PDU size that is best suited for the indicated radio conditions. For example, the RLC controller 36 may select a large RLC PDU size and then evaluate whether the calculated RLC data rate drops. If so, the RLC controller 36 may revert to a smaller RLC PDU size and again evaluate the RLC data rate.

Of course, while exemplified above in the context of calculating an instantaneous RLC data rate, the RLC controller's adaptation may instead be based on calculating an average RLC data rate. Or, the adaptation may be based on high-order RLC data rate information, such as trends in the RLC data rate. For instance, the RLC controller 36 may determine from positive RLC PDU acknowledgments whether the RLC data rate is trending downward or upward. If trending downward, the RLC controller 36 applies a smaller RLC PDU size, but if trending upward the RLC controller 36 applies a larger PDU size.

The particular manner in which the controller 38 calculates RLC PDU data rate may in some cases depend on the frequency with which it receives RLC PDU status reports from the UE 18. In this regard, the system 10 may direct the UE 18 to use a faster or slower reporting cycle as needed for the RNC 14 to calculate RLC PDU data rate in a certain way. Note that in some cases the system 10 could even direct the UE 18 to use a faster reporting cycle than the RLC PDU round trip time (RTT).

In at least one other embodiment, the indirect indicator relates to the RLC data rate as seen from the perspective of the RNC 14 rather than the UE 18. In this case, the indirect indicator may comprise the rate at which downlink RLC PDU sequence numbers are consumed at the RNC 14. In general, the faster the rate at which such sequence numbers are consumed, the higher the RLC data rate and the better the radio conditions at the UE 18. Conversely, the slower the rate at which sequence numbers are consumed, the lower the RLC data rate and the worse the radio conditions at the UE 18. RLC PDU sequence number consumption rate therefore relates to the RLC data rate from the perspective of the RNC 14 and indirectly indicates the radio conditions at the UE 18.

Provided with such an indirect indicator, the RLC controller 36 dynamically adapts the size of downlink RLC PDUs based on the RLC PDU sequence number consumption rate. The controller 36 may, for instance, calculate or derive the RLC data rate from the consumption rate and then actually adapt RLC PDU size as a function of the RLC data rate, in much the same way as described above with respect to positive RLC PDU acknowledgements. Alternatively, the controller 36 may actually make size adaptations as a function of the consumption rate. For example, the RLC controller 36 may target a certain consumption rate and make adjustments to the RLC PDU size as needed for the observed consumption rate to match the target rate. In some embodiments this may entail determining whether the observed consumption rate is higher or lower than a threshold value. If the consumption rate is higher than the threshold value, the controller 36 increases RLC PDU size. But if the consumption rate is lower, the controller 36 decreases RLC PDU size.

Those skilled in the art will of course appreciate that the above embodiments have been described as non-limiting examples, and have been simplified in many respects for ease of illustration. For instance, the above embodiments have not been described in the context of any particular type of wireless communication system. In this regard, no particular communication interface standard is necessary for practicing the present invention. That is, the wireless communication system 10 may be any one of a number of standardized system implementations which include an RNC configured to communicate with a UE via a base station that is geographically separated from the RNC.

As one particular example, the system 10 may implement HSPA or HSPA Evolution standards as defined by 3GPP. The system 10 may even include features such as Dual or Multi-Carrier HSDPA (High Speed Downlink Packet Access) with Multiple-Input Multiple-Output (MIMO) (Release 9) or Multi-Carrier HSDPA (Release 10). Regardless, the MAC layer at the base station 12 in such a system 10 may more specifically comprise a MAC-ehs sublayer that constrains the number of RLC PDUs that can be sent per MAC-ehs PDU. Advantageously, in the case where the system 10 comprises an HSPA-based system, minimal modification to existing HSPA standards is required, since only the RNC 14 need be modified and no new or additional control signaling need be introduced.

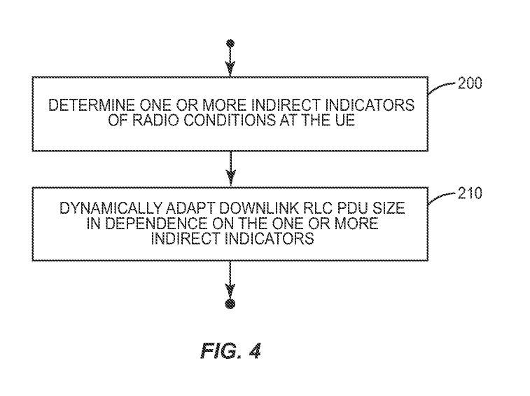

With the above described modifications and variations in mind, those skilled in the art will understand that the RNC 14 generally performs the processing illustrated in FIG. 4. As shown, processing includes determining one or more indirect indicators of radio conditions at the UE 18 (Block 200). Processing further includes dynamically adapting the size of downlink RLC PDUs sent to the UE 18 over the RLC link 26, in dependence on those one or more indirect indicators (Block 210).

Those skilled in the art will also appreciate that the various “circuits” described may refer to a combination of analog and digital circuits, and/or one or more processors configured with software stored in memory 38 and/or firmware stored in memory 38 that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method implemented by a radio network controller (RNC) configured to communicate with a user equipment (UE) over a Radio Link Control (RLC) link via a base station geographically separated from the RNC, the method comprising:
determining one or more indirect indicators of radio conditions at the UE; and
dynamically adapting the size of downlink RLC Protocol Data Units (PDUs) sent to the UE over the RLC link, in dependence on the one or more indirect indicators.

2. The method of claim 1, wherein at least one of the indirect indicators relates to at least a relative geographic location of the UE.

3. The method of claim 2, wherein the at least one indirect indicator comprises the number of cells included in an active set of the UE, which cells are included in the active set, or both, wherein the active set includes cells to which the UE is connected.

4. The method of claim 2, wherein the at least one indirect indicator comprises the power with which the UE has received a common pilot channel transmitted from a neighboring cell.

5. The method of claim 2, wherein the at least one indirect indicator comprises actual geographic location information for the UE.

6. The method of claim 1, wherein at least one of the indirect indicators relates to the rate at which downlink RLC PDUs are sent or received over the RLC link.

7. The method of claim 6, wherein the at least one indirect indicator comprises the number of positive RLC PDU acknowledgments received from the UE over a period of time.

8. The method of claim 6, wherein the at least one indirect indicator comprises the rate at which downlink RLC PDU sequence numbers are consumed at the RNC.

9. The method of claim 1, wherein said dynamically adapting comprises increasing or decreasing said size depending on whether said radio conditions have improved or worsened, respectively, as indicated by said one or more indirect indicators.

10. The method of claim 1, wherein said dynamically adapting comprises:
evaluating the one or more indirect indicators to determine in which of a plurality of predefined qualitative ranges the radio conditions at the UE fall; and
adapting said size responsive to changes in the qualitative range in which the radio conditions at the UE fall.

11. The method of claim 1, wherein said dynamically adapting comprises determining said size based on a defined mapping between different RLC PDU sizes and values or ranges of values for the one or more indirect indicators.

12. A radio network controller (RNC) comprising:
a communication interface configured to communicate with a user equipment (UE) over a Radio Link Control (RLC) link via a base station geographically separated from the RNC;
a determination circuit configured to determine one or more indirect indicators of radio conditions at the UE; and
an RLC controller configured to dynamically adapt the size of downlink RLC Protocol Data Units (PDUs) transmitted over the RLC link, in dependence on the one or more indirect indicators.

13. The RNC of claim 12, wherein at least one of the indirect indicators relates to at least a relative geographic location of the UE.

14. The RNC of claim 13, wherein the at least one indirect indicator comprises the number of cells included in an active set of the UE, which cells are included in that active set, or both, wherein the active set includes cells to which the UE is connected.

15. The RNC of claim 13, wherein the at least one indirect indicator comprises the power with which the UE has received a common pilot channel transmitted from a neighboring cell.

16. The RNC of claim 13, wherein the at least one indirect indicator comprises actual geographic location information for the UE.

17. The RNC of claim 12, wherein at least one of the indirect indicators relates to the rate at which downlink RLC PDUs are sent or received over the RLC link.

18. The RNC of claim 17, wherein the at least one indirect indicator comprises the number of positive RLC PDU acknowledgments received from the UE over a period of time.

19. The RNC of claim 17, wherein the at least one indirect indicator comprises the rate at which downlink RLC PDU sequence numbers are consumed at the RNC.

20. The RNC of claim 12, wherein the RLC controller is configured to dynamically adapt the size of downlink RLC PDUs by increasing or decreasing said size depending on whether said radio conditions have improved or worsened, respectively, as indicated by said one or more indirect indicators.

21. The RNC of claim 12, wherein the RLC controller is configured to dynamically adapt the size of downlink RLC PDUs by:
evaluating the one or more indirect indicators to determine in which of a plurality of predefined qualitative ranges the radio conditions at the UE fall; and
adapting said size responsive to changes in the qualitative range in which the radio conditions at the UE fall.

22. The RNC of claim 12, wherein the RLC controller is configured to dynamically adapt the size of downlink RLC PDUs by determining said size based on a defined mapping between different RLC PDU sizes and values or ranges of values for the one or more indirect indicators.
